(19) United States
(12) Patent Application Publication
(10) Pub. No.: US 2007/0028975 A1
(43) Pub. Date: Feb. 8, 2007

(54) Mixer valve

(76) Inventors: William Peter Herring, Bath (GB); James Moore, Somerset (GB)

Correspondence Address: STITES & HARBISON PLLC, 1199 NORTH FAIRFAX STREET, SUITE 900, ALEXANDRIA, VA, 22314, US

(21) Appl. No.: 11/496,508

(22) Filed: Aug. 1, 2006

(30) Foreign Application Priority Data
Aug. 8, 2005 (GB) 0516263.1

(51) Int. Cl. F16K 11/18

(52) U.S. Cl. 137/636

(57) ABSTRACT

A mixer valve is shown which has two valves controllable by a mix controller to determine the ratio of fluid entering the mixer valve from two respective inputs, such as a hot fluid input and a cold fluid input, and a third valve controllable by a flow controller to determine the flow rate of fluid out of the mixer valve. Thus, the mixing proportion of the input fluids and the output flow rate are independently controllable. The mixer valve is suitable for incorporation into a mixer tap.

### BACKGROUND OF THE INVENTION

1. Field of the Invention

The present invention relates to mixer valves, i.e. units which receive two or more fluid inputs (e.g. hot and cold water) and are arranged controllably to produce a mixed fluid output. Mixer valves are typically used in taps (faucets), showers and the like.

2. Summary of the Prior Art

Conventional mixer valves typically have a housing which receives two fluid inputs and provides them to a mixing unit which comprises two ceramic discs, which are movable relative to one another. In one arrangement, one of the ceramic discs is fixed in the housing with the other being movable by an external controller. The fixed disc has two holes therethrough which receive fluid from the respective inputs. The fixed disc has another hole in fluid communication with an outlet to permit fluid to leave the housing. The movable plate includes a mixing chamber (e.g. a recess) which can selectively join either or both input holes to the output hole so that fluid can flow from the inputs to the outlet, mixing in the mixing chamber as it does so.

The above type of arrangement is used in a single lever mixing cartridge, which provides separate control of the mixing proportion and flow rate through the provision of a single control lever that is movable in two distinct ways. Typically, the lever is tiltable to control flow rate, e.g. by moving the mixing chamber into or out of fluid communication with the input holes, and rotatable to control mixing proportion (e.g. temperature). However, such complex movement is not always easily or conveniently controllable, e.g. in small spaces or where the mixer valve needs to be at a distance from an operating device.

US 2005/0076960 proposes a mixer valve where the hot and cold inputs are connected to respective valve cartridges, which are independently operated by separate tap controllers. The valve cartridges used are standard: fluid is received into the base, and flows out of an outlet in the cartridge side wall under the control of a valve, which is operated by a rotatable control spindle which protrudes from the top of the cartridge. There is a geared connection between the tap controllers (e.g. handle) and the control spindles of the valve cartridges. The gearing ratio is arranged to give make the operation angle of the tap controllers larger than the operation angle of its respective cartridge control spindle. This can give greater mechanical advantage and facilitate temperature control. However, the flow rate out of the mixer valve is not easily controlled without affecting the mixing proportion (temperature) of the output fluid.

### SUMMARY OF THE INVENTION

One aim of the present invention is to provide an improved mixer valve where mixing proportion and output flow rate are independently controllable in a simple fashion. Combinations of different types of motion (e.g. the tilting and rotating of known devices) is preferably avoided; for example, the mixing proportion and output flow rate may be controllable using only rotational motion.

At its most general, the present invention provides a mixer valve having three valve portions associated with fluid inputs and outputs so that fluid flow out of the mixer valve is controllable separately from (i.e. independently of) the proportion of fluid received from each input.

Thus, according to the present invention there is provided a mixer valve for mixing fluid received from first and second inputs to provide an output of mixed fluid, the mixer valve having: a first valve with an inlet in fluid communication with the first input; a second valve with an inlet in fluid communication with the second input; a third valve with an inlet in fluid communication with outlets of the first and second valves, and an outlet arranged to provide the output of mixed fluid; a mix controller arranged to operate the first and second valves; and a flow controller arranged to operate the third valve. The flow controller may therefore control the flow rate of fluid leaving the mixer valve. The flow controller may be able to completely close the third valve so that no fluid may leave the mixer valve. The operation of the flow controller is independent of the operation of the mix controller, so that the flow rate of fluid leaving the mixer valve may be controllable without affecting the mix proportion of the input fluid.

Preferably the mixer valve comprises a housing which contains the first, second and third valves. The housing may enclose a mixing chamber forming part of the fluid communication between the outlets of the first and second valves and the inlet of the third valve, the mixing chamber providing a space to promote thorough mixing so that the output is a substantially uniform mixture of the input fluids.

Preferably, the mix controller is arranged to operate the first and second valves in a complementary fashion. The first and second valves are preferably controlled by a common mix control element. The common mix control element may interconnect the first and second valves, so that when the first valve opens the second valve closes and vice versa. Such an interconnected controller promotes smooth variation of the input mix proportion. The combined flow rate from the fluid outlets of the first and second valves may be constant, although this may in practice depend on the fluid pressures of the inputs. This means that a constant input flow may be provided to the third valve, which therefore improves the control the third valves gives over output flow rate.

Preferably, one or more or all of the first, second and third valves are standard ceramic valve cartridges. Preferably, each valve cartridge has its input in its base and a valve plate or plates arranged to open or close a fluid passageway between the base and the outlet to permit fluid flow out of the outlet when the passageway is open.

Preferably, each valve cartridge has an control spindle (e.g. upstanding from the cartridge) which is rotatable to open and close the valve. In the preferred embodiment, the bases of two of the valve cartridges are attached to the fluid inputs, i.e. a first valve cartridge may receive hot water, and the second valve cartridge may receive cold water. The output supplies of the first and second valve cartridges are preferably in fluid communication with the base of a third valve cartridge. In this arrangement, a mixing chamber may be provided in the volume (space) between the output suppliers of the first and second valve cartridge and the base of the third valve cartridge.

The output supply of the third valve may be directly connectable to a conduit or other fluid conveying means in order to carry fluid from the mixer valve to an outlet apparatus, e.g. tap. Of course, the mixer valve may be an internal or even integral component of such an outlet apparatus.

Preferably, the mix controller is arranged to rotate the control spindles of the first and second valve cartridges. Preferably, rotation of the control spindles is controlled in a complementary fashion, i.e. a common control element may interconnect them to cause rotation of both control spindles.

Preferably, a first mix controller operation causes the first valve cartridge to open and the second valve cartridge to close, and a second mix controller operation causes the second valve cartridge to open and the first valve cartridge to close. The common control element may be a rotatable shaft, and the first and second mix controller operations preferably correspond to opposite senses of rotation of the shaft.

The control spindles of the first and second valve cartridges may have gears attached to them that are operably connected to a main gear or other drive means rotatable by the mix controller. Preferably, the mix controller includes a rotatable shaft coupled to the main gear.

The gearing ratio between the main gear and gears attached to the control spindles may be 1:1, or there may be a step-up or step-down arrangement. Preferably the ratio is the same for both control spindles. For example, a step-down arrangement, which may give the rotatable shaft a larger operation angle than the valve cartridge control spindle, may be used to give improved leverage. Alternatively, a step-up arrangement, which may give the rotatable shaft a smaller operation angle than the valve cartridge control spindle, may be used to reduce the amount of movement required by the rotatable shaft. This can be useful where space is limited. Thus, a conventional quarter turn valve cartridge (having an operation angle of 90° between full open and full closed) may require the rotatable shaft to be rotated by more than 90° (e.g. 120° or more) in a step-down mechanism, or by less than 90° (e.g. 600 ° or less) in a step-up mechanism.

The rotatable shaft is preferably adapted to be connected to a user-operated mechanism belonging to an outlet (e.g. tap) assembly. The user-operated mechanism may be a conventional rotary handle. The rotatable shaft may be connected to it by conventional means, e.g. a splined head matingly receivable in a correspondingly splined recess.

Preferably, the flow controller is arranged to rotate the control spindle on the third valve cartridge. This may also be achieved by a gear attached to the control spindle which is operably connected (e.g. meshed with) a main gear or other drive means rotatable by the flow controller. As above, the gearing ratio between the main gear and gear attached to the control spindle may be 1:1, or there may be a step-up or step-down arrangement, depending on the constraints of leverage and/or space.

Preferably, the flow controller includes a rotatable shaft coupled to it main gear. The rotatable shaft is preferably adapted to be connected to a user-operated mechanism belonging to an outlet (e.g. tap) assembly. For example, the user-operated mechanism may be a conventional rotary handle, or a tiltable lever, etc.

Both the mix controller and flow controller may include rotatable shafts to operate their respective valve cartridges. In this case, the rotatable shafts may be coaxial. For example, the control shaft for one of the mix or flow controller may be a sleeve surrounding and rotatable relative to the rotatable shaft for the other controller. Preferably, the main gears attached to the rotatable shafts also rotate about a common axis. Preferably they are axially displaced to avoid interfering with one another and cluttering the interior of the mixer valve. Since the gears attached to the valve cartridges have a limited rotational extent, the main gears may be provided with meshing teeth only around part of their circumference. This can save space inside the mixer valve and also lead to a more lightweight product.

A mixer valve as described above has general applicability, and may be incorporated in all types of mixer taps, or with the fluid outlet assemblies that require mixing. Another aspect of the present invention may provide a fluid outlet assembly or mixer tap that includes such a mixer valve. The mixer valve may be incorporated into the housing of such an assembly, or it may be located out of sight (e.g. behind a wall or below a work surface).

### BRIEF DESCRIPTION OF THE DRAWINGS

Examples of the present invention will now be described with reference to the accompanying drawings, in which:

FIG. 1 shows a mixer tap having a mixer valve according to an embodiment of the invention;

FIG. 2 shows a cross-section along the line A-A of the mixer tap shown in FIG. 1;

FIG. 3 shows a close-up perspective view of the mixer valve shown in FIG. 1;

FIG. 4 shows the opposite view of the mixer valve shown in FIG. 3;

FIG. 5 shows a side view of a mixer valve which is an embodiment of the invention in isolation;

FIG. 6 shows a cross-section along the line C-C through the mixer valve of FIG. 5;

FIG. 7 shows a cross-section taken along the line B-B of the mixer valve shown in FIG. 5;

FIG. 8 shows another side view of the mixer valve shown in FIG. 5;

FIG. 9 shows a cross-section through the line E-E of the mixer valve shown in FIG. 8;

FIG. 10 shows a cross-section taken along the line D-D of the mixer valve shown in FIG. 8;

FIG. 11 shows a perspective view of another mixer tap having a mixer valve which is an embodiment to the present invention;

FIG. 12 shows a side view of the mixer tap shown in FIG. 11 when mounted on a work surface; and

FIG. 13 shows a cross-section taken along the line F-F of the mixer tap shown in FIG. 12.

### DETAILED DESCRIPTION

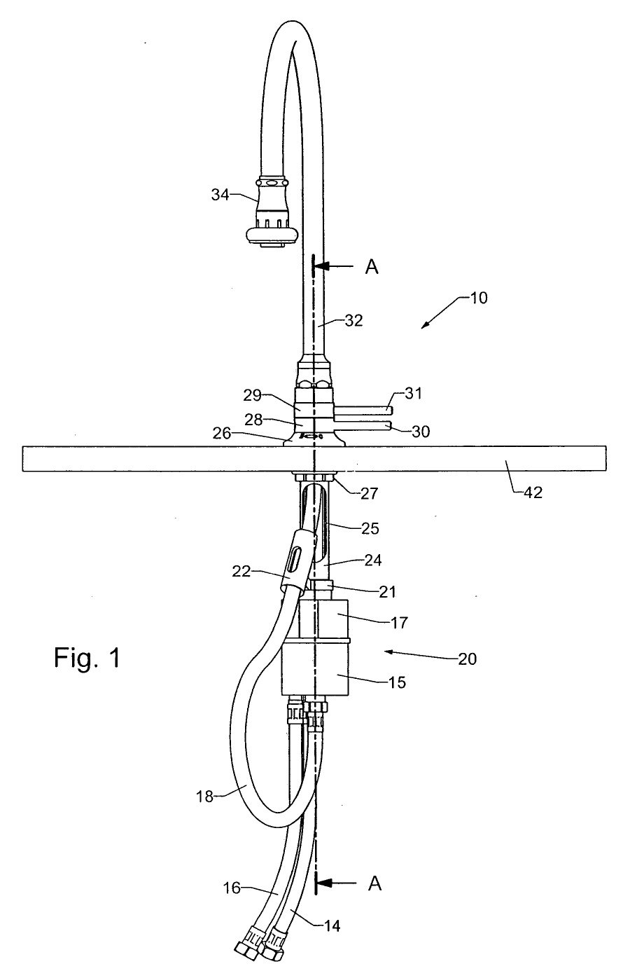

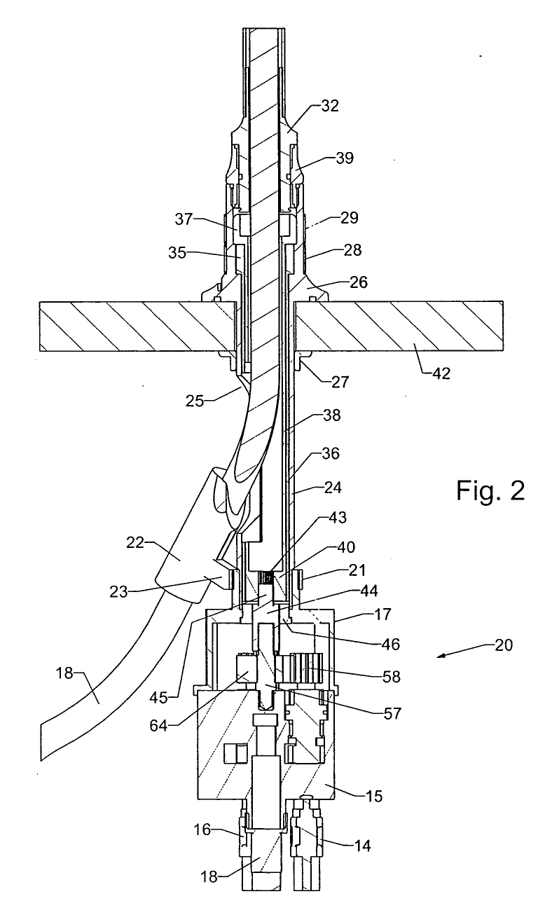

FIG. 1 shows a mixer tap 10 that incorporates a mixer valve 20 that is an embodiment of the present invention. The mixer valve 20 includes a housing 15 arranged to receive fluid inputs via supply conduits 14,16 from main hot and cold water supply pipes respectively. An output conduit 18 extends away from the bottom of housing 15 and loops around the mixer valve 20 to be fed through a hole in the work surface 42 into a spout 32, terminating in a conventional spray head 34. The spout 32 is mounted on the work surface via a housing 26. A rigid upstanding tube 24 extends through a hole in the work surface 42 and has the mixer valve 20 mounted on it via casing 17. The tube 24 is secured in place, i.e. prevented from rotating or moving axially with respect to the work surface 42, by a backing nut 27. A cut-out hole 25 is formed in the tube 24 to allow the output conduit 18 to pass into the tube and through a passageway in the middle of the housing 26. A guide pipe 22 is attached by a ring 21 and lug 23 (see FIG. 2) to the tube 24. The guide pipe 22 helps to orientate the output conduit 18 correctly so that it enters the cut-out 25 in the tube 24 without excessive bending or interference from the edges of the cut-out 25.

As shown in detail in FIG. 2, rotatable radially protruding levers 30,31 are operably connected to rotatable control elements 44,46 in the mixer valve 20. The levers 30,31 are used to control the mixing proportion of hot and cold water received in the mixer valve and the output flow rate of fluid away from the mixer valve in the manner described in detail below.

In FIG. 2, it can be seen that housing 26 is formed in one piece with tube 24, and has control sleeves 36,38 coaxially mounted therein. The spout 32 is mounted in the top part of housing 26, where it is held in place by stopper 39. The control sleeves 36,38 are able to rotate relative to one another and to the tube 24. Inner control sleeve 38 has an upper head portion 37 connected to lever 31, and outer control sleeve 36 has an upper head portion 35 connected to lever 30. These connections are covered by respective trim covers 28,29. Both the control sleeves 36,38 have cut-out portions arranged to overlap with the cut-out 25 in tube 24 to enable the output conduit 18 to pass cleanly into the inside of the housing 26. The gearing ratios described below may be selected to give a small operation angle to the control sleeves 36,38 so that cut-outs having a smaller circumferential extent can still fully overlap with the cut-out 25 in tube 24.

The base 40 of inner control sleeve 38 has a central, internally splined, through hole 43 arranged to matingly receive a correspondingly splined upstanding peg 45 of flow control element 44. Thus, rotation of inner control sleeve 38 (via upper lever 31) causes rotation of flow control element 44.

Outer control sleeve 36 is connected to mix control element 46, so that rotation of lower lever 30 causes rotation of the mix control element 46.

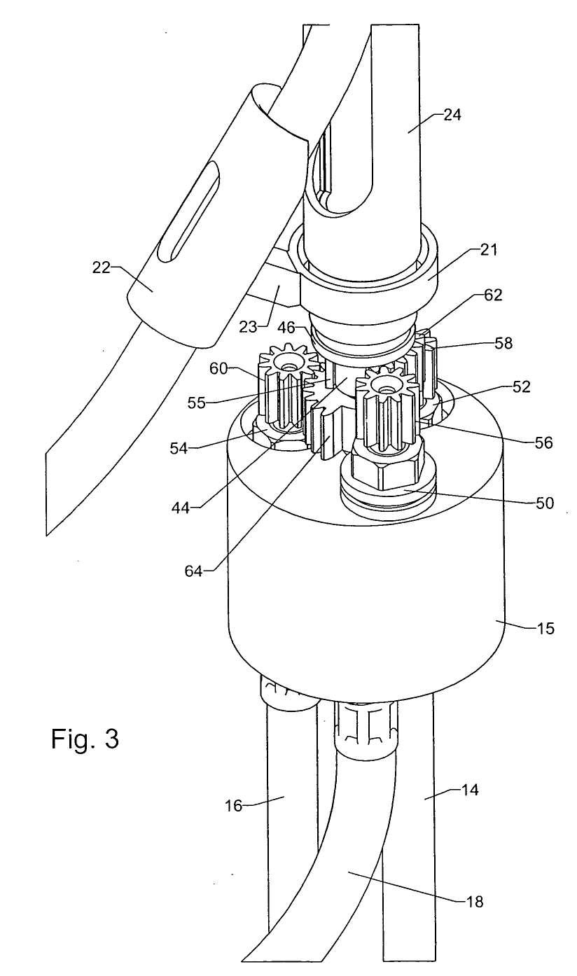

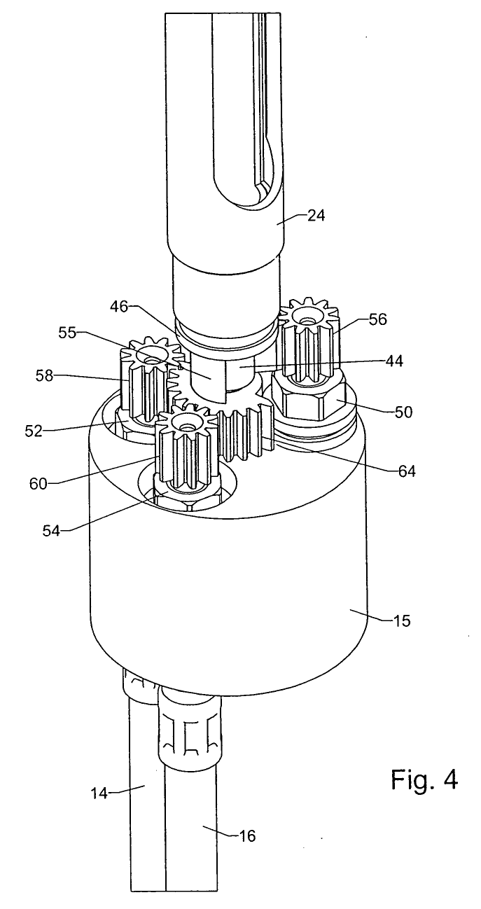

As shown in FIGS. 3 and 4, flow control element 44 has a toothed gear 62 radially protruding therefrom so as to mesh with a gear wheel 56 mounted on the control spindle (not shown) of a conventional ceramic disc valve cartridge 50. Meanwhile, mix control element 46, which is formed in the shape of an annulus, thereby allowing flow control element 44 to pass through it, has a depending connector plate 55 attached to another gear 64, whose radially protruding teeth mesh with gears 58,60 mounted on the control spindles (not shown) of two further ceramic plate valve cartridges 52,54. To maintain smooth rotation, the gears 62,64 controlled by the flow and mix control elements 44,46 are rotatably mounted on an upstanding axle 57, which is mounted in the base 15 of the mixer valve 20. Outer casing 17 securely attaches base 15 to a tube 24 to prevent the base 15 from rotating when the mix or flow control elements 44,46 are rotated. Casing 17 also acts as a protective cover for the gear mechanism.

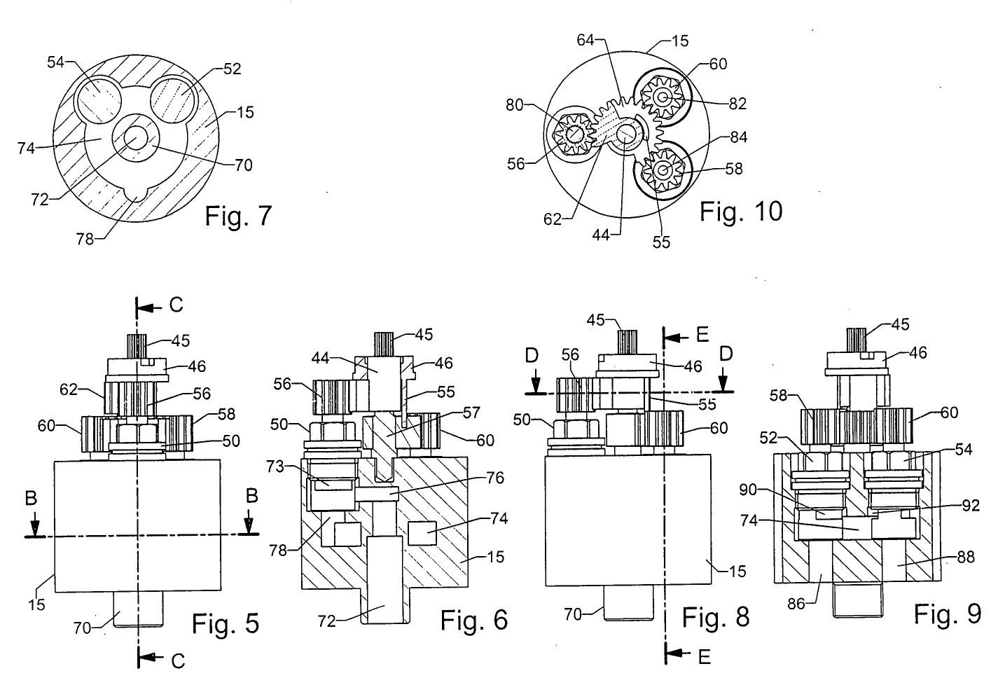

FIGS. 5 to 9 show the internal configuration of the mixer valve 20 in more detail. Briefly, the input fluid supplies 14,16 are respectively connected to the inputs of valve cartridges 52,54, whose control spindles are operated by mix control element 46. The outlets from these valve cartridges 52,54 are connected to the inlet of valve cartridge 50, whose control spindle is operated by flow control element 44. The outlet of valve cartridge 50 is connected to output conduit 18 so that any fluid flowing out of the mixer valve 20 is carried by output conduit 18 to spray head 34.

In detail, FIG. 5 shows the outlet tube 70 to which the output conduit 18 is attached. As shown in FIG. 6, a central passageway 72 is formed inside the base 15 to carry fluid out of the tube 70. Fluid is provided to the central passageway 72 from the outlet 73 of the valve cartridge 50 via a radial passageway 76. Fluid enters the inlet of valve cartridge 50 from upstanding passageway 78, which is in fluid communication with mixing chamber 74, which has an annular form, as shown in FIG. 7. Thus, fluid entering the mixing chamber 74 flows into valve cartridge 50 via upstanding passageway 78. If the valve is open, the fluid will leave the mixer valve 20 via passageways 72,76. The outlets of the valve cartridges that receive fluid input open into mixing chamber 74.

FIG. 8 shows another side view of the mixing valve 20, where the axial displacement of the valve cartridges 50,52,54 can clearly be seen. Valve cartridge 50 projects further out of the base 15 than valve cartridges 52,54. This allows the operating gears 62,64 to be axially displaced from one another. In fact it allows them to share a common axis whilst maintaining their independence. It also allows the mixer valve 20 to be compact in the radial direction.

The cross-section of FIG. 9 demonstrates how fluid is provided from the first two valve cartridges 52,54 to the mixing chamber 74. Fluid enters upright passageways 86,88 from input supplies 14,16. Input passageways 86,88 respectively carry the fluid into the inlets of valve cartridges 52,54. The outlets 90,92 of valve cartridges 52,54 are in fluid communication with the mixing chamber 74.

FIG. 10 shows that a single gear 64 is used to control both gears 58,60 mounted on the control spindles 82,84 of valve cartridges 52,54. Since output flow rate is controlled separately by the action of gear 62 with gear 56 (which is shown mounted on the control spindle 80 of valve cartridge 50 in FIG. 10), there is no need for the mix control mechanism to exhibit any flow rate control. In other words, mix control mechanism need not cause both valves to be closed at the same time. That is, the mechanism represented by main gear 64 and valve cartridge gears 58,60 need only present the capability of varying the relative proportion of fluid permitted through valve cartridges 52,54. At one extreme, valve cartridge 52 is fully open and valve cartridge 54 is fully closed. The other extreme is represented by valve cartridge 52 being fully closed and valve cartridge 54 being fully open. By setting the initial position of the control spindles and main gear 64 correctly, the relative proportion of fluid permitted through valve cartridges 52,54 can be varied smoothly (e.g. linearly) between these two extremes. This is brought about by meshing equally sized gears 58,60 with the same main gear 64.

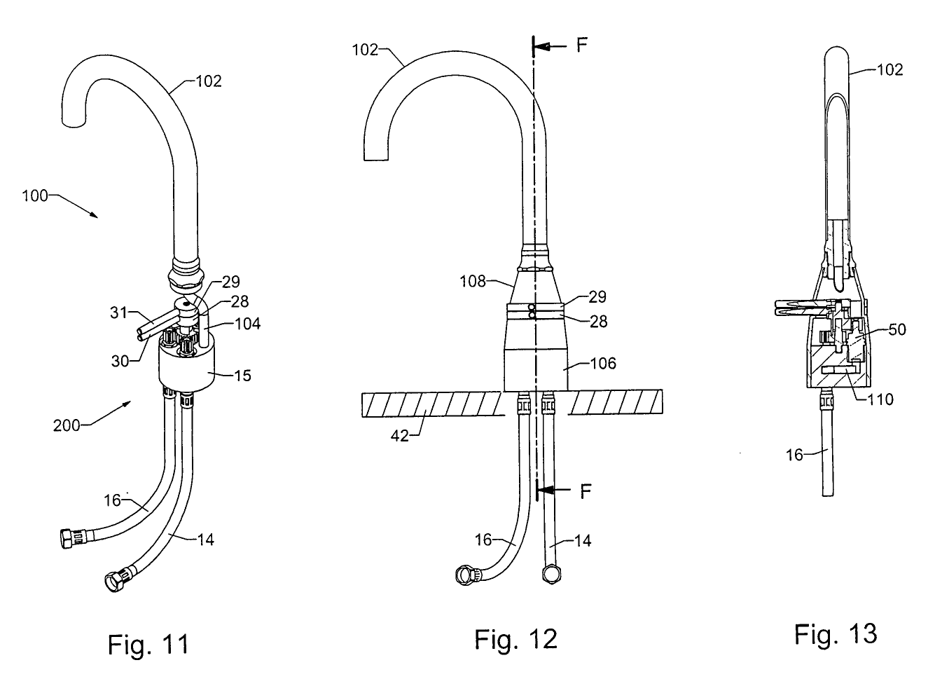

FIGS. 11 to 13 show a mixer tap 100 with another mixer valve 200 according to the present invention. As shown in FIG. 12, mixer valve 200 is arranged to be mounted above the work surface 42 within the main housing 106,108 of a mixer tap assembly 100. As before, input supplies 14,16 are connected to the base 15 of the mixer valve 200. Radially protruding levers 30,31 are turned to rotate gears in the same way as shown in FIGS. 5 to 9. As the mixer valve 200 is above the work surface in this embodiment, there is no need for control sleeves to connect the levers 30,31 to the mix and flow control elements. Connection is more direct, as shown in FIG. 11.

One difference in this embodiment is that the output from valve cartridge 50 is provided to a supply pipe 104 that extends out of the top of base 15 and is connected to the base of spout 102. Other than this, the internal mechanisms of the mixer valve 200 are the same as those illustrated in FIGS. 5 to 9. FIG. 13 shows the presence of a mixing chamber 110.

In use, therefore, the user operates one of the radially protruding levers 30,31 to control the flow rate of fluid ejected from the mixer valve 20,200 to be carried to the spout or other outlet of the assembly in which the mixer valve is mounted. Independently of the flow rate, the user can control the mixing proportion (i.e. the temperature, where the fluid inputs are hot and cold water) of the ejected fluid by operating the other one of the radially protruding levers 30,31.

What is claimed is:

1. A mixer valve for mixing fluid received from first and second inputs to provide an output of mixed fluid, the mixer valve having:
a first valve with an inlet in fluid communication with the first input, and an outlet;
a second valve with an inlet in fluid communication with the second input, and an outlet;
a third valve with an inlet in fluid communication with the outlets of the first and second valves, and an outlet arranged to provide the output of mixed fluid;
a mix controller arranged to operate the first and second valves; and
a flow controller arranged to operate the third valve.

2. A mixer valve according to claim 1, wherein the mix controller includes a common mix control element to operate the first and second valves.

3. A mixer valve according to claim 2, wherein the common mix control element is a rotatable shaft.

4. A mixer valve according to claim 3, wherein the flow controller includes a rotatable shaft to operate the third valve, and the rotatable shaft of one of the flow controller or mix controller is a sleeve surrounding and rotatable relative to the rotatable shaft of the other one of the flow controller or mix controller.

5. A mixer valve according to claim 1, arranged such that the mix controller is connected to the first and second valve such that actuation of the mix controller results in simultaneous operation of the first and second valves.

6. A mixer valve according to claim 1, wherein each of the first and second valves has a control spindle with a gear attached to it that is operably connected to a main gear rotatable by the mix controller.

7. A mixer valve according to claim 6, wherein the main gear rotatable by the mix controller has teeth only around part of its circumference.

8. A mixer valve according to claim 1, wherein the third valve has a control spindle with a gear attached to it that is operably connected to a main gear rotatable by the flow controller.

9. A mixer valve according to claim 8, wherein the main gear rotatable by the flow controller has teeth only around part of its circumference.

10. A mixer tap assembly including a mixer valve, the mixer valve being according to claim 1.

11. A tap and work surface assembly comprising a mixer tap assembly connected to a work surface, the mixer tap assembly being according to claim 10.
